(19) United States
(12) Patent Application Publication
(10) Pub. No.: US 2026/0208929 A1
(43) Pub. Date: Jul. 23, 2026

(54) ADVANCED VACUUM CAP SYSTEM FOR FLUID MANAGEMENT AND PRESERVATION

(71) Applicant: Ahmet Abdullah Gokcen, Austin, TX (US)

(72) Inventor: Ahmet Abdullah Gokcen, Austin, TX (US)

(21) Appl. No.: 19/570,359

(22) Filed: Mar. 18, 2026

(51) Int. Cl. B65D 51/30; B01D 53/26; B01F 27/13; B01F 27/96

(52) U.S. Cl. CPC B65D 51/30; B01D 53/26; B01F 27/13; B01F 27/96; B01D 2257/80

(57) ABSTRACT

A vacuum cap assembly configured to be mounted on an opening of a container to manage the internal environment of stored materials. The cap assembly includes a cap housing (202) having a dedicated vacuum port (102) for connection to an external vacuum source to evacuate air from a container headspace, a motor-driven mixing assembly with a mixing shaft (208) extending into the container for maintaining homogeneity of contents, and a passive moisture-control element positioned within the cap housing for absorbing residual moisture. The vacuum port (102) is structurally separate from the mixing shaft (208) such that vacuum is not transmitted through the mixing assembly. The cap assembly enables evacuation of air, internal mixing, and moisture removal while the container remains sealed, thereby improving material stability and reducing exposure to ambient conditions during storage.

### CROSS REFERENCE TO RELATED APPLICATIONS

This patent application claims the benefit of U.S. Provisional Patent Application No. 63/720,809 filed on Nov. 15, 2024.

### FIELD OF THE INVENTION

The present invention relates generally to container closure and fluid preservation technologies. More particularly, the invention relates to an integrated vacuum cap assembly configured to be mounted on a container opening for controlling the internal atmospheric and physical conditions of stored materials. The invention combines vacuum evacuation of container headspace, passive moisture absorption, and internal mixing of container contents within a single modular cap structure.

The invention is applicable to storage and preservation of liquids, suspensions, emulsions, slurries, and other flowable materials that are sensitive to oxygen exposure, moisture ingress, contamination, or phase separation. Representative applications include chemical formulations, coatings, adhesives, resins, catalysts, pharmaceutical preparations, laboratory reagents, food and beverage products, and industrial process fluids requiring controlled storage environments and maintained homogeneity.

The invention further relates to container closures incorporating integrated mixing mechanisms and atmosphere-conditioning elements, and more specifically to a vacuum-cap system that enables evacuation, moisture control, and agitation of stored material while the container remains sealed.

### BACKGROUND OF THE INVENTION

Storage containers and tanks used for holding liquids, semi-liquids, or flowable materials are widely employed across industrial, laboratory, commercial, and processing environments. In many such applications, the integrity of the stored material must be preserved over extended periods of time. Conventional container closures are typically limited to simple sealing functions, such as threaded caps, snap-fit lids, or gasketed covers, which primarily act as physical barriers to the external environment. While these closures can reduce direct exposure to ambient air, they do not actively control the internal conditions within the container once it has been sealed.

A persistent challenge in containerized storage is the presence of residual air and moisture trapped within the container headspace at the time of sealing. Oxygen and water vapor can adversely affect stored materials by accelerating degradation, altering composition, or reducing shelf life. In many cases, containers are repeatedly opened to access contents, further introducing ambient air and humidity into the internal environment. Conventional caps do not provide a means to remove or regulate these internal conditions once the container is closed.

To address air exposure, various vacuum-based storage solutions have been developed. These typically rely on external vacuum devices used intermittently to evacuate air from a container through a valve or adapter. However, such systems often require additional components, specialized fittings, or manual intervention, and they are not integrated into the container closure itself. As a result, vacuum application is inconsistent, inconvenient, or prone to leakage over time, particularly when containers are opened and resealed multiple times.

Moisture control presents a separate but related challenge. Passive moisture-absorbing elements, such as desiccant packets, are sometimes placed directly inside containers to absorb humidity. While such elements can reduce moisture levels to some extent, they are often limited in effectiveness, difficult to replace, or poorly positioned relative to the container headspace. Additionally, conventional closures do not provide a structured or controlled environment for integrating moisture-control elements in a way that maintains a sealed internal atmosphere. In certain applications, the stored material may be moisture-sensitive and/or oxygen-sensitive (e.g., hygroscopic or hydrolysis-prone formulations). Non-limiting examples include isocyanate-containing formulations, moisture-curing polyurethane systems, reactive resins and catalysts, solvent-borne coatings, chemical intermediates, pharmaceutical or laboratory solutions, and other liquids whose properties may degrade upon exposure to humidity or oxygen. The system described herein is particularly beneficial for such materials, although it is not limited thereto.

Another common issue associated with stored liquids and flowable materials is settling, stratification, or separation over time. Materials containing additives, suspended particles, or blended components often require periodic mixing to maintain uniformity. In conventional practice, this is accomplished by manually shaking the container or by opening the container and using an external mixing device. Both approaches disrupt the sealed environment of the container and reintroduce air and moisture, thereby undermining preservation efforts.

Various prior art references disclose container closures incorporating moisture-absorbing materials within a cap or lid structure. For example, desiccant cap systems described in U.S. Pat. Nos. 4,350,508 and 4,146,277 disclose container caps that house desiccant material to reduce humidity within a container headspace. These systems are primarily directed toward passive moisture control and are effective in reducing humidity exposure for stored contents. However, such desiccant caps are limited in function to moisture absorption alone and do not provide any mechanism for actively evacuating air from the container or for mixing the container contents while the container remains sealed.

More recent desiccant bottle cap designs, such as those described in US 2005/0172814 A1, further refine the integration of desiccant elements into container closures and emphasize replaceability or attachment of the desiccant to the cap interior. While these designs improve usability and moisture control, they similarly lack any provision for controlled vacuum application or internal agitation. As such, they do not address degradation mechanisms associated with trapped oxygen, nor do they prevent settling or stratification of stored materials.

Other prior art references focus on agitation or mixing mechanisms integrated into container openings. For example, U.S. Pat. No. 5,193,908 discloses an agitator assembly mounted through a drum opening, wherein a rotating shaft and blade structure are used to agitate contents and, in some embodiments, transfer material through a hollow shaft. While this reference teaches agitation through a container closure, it relies on a hollow shaft structure that functions as a conduit for fluid transfer. Such designs differ fundamentally from the present invention, which employs a solid mixing shaft 208 that does not form part of any vacuum or fluid flow path and is used solely to transmit rotational motion for mixing.

Additionally, known industrial vacuum mixing systems and vacuum homogenizers demonstrate that vacuum application and mixing may be combined within large-scale processing equipment. However, these systems are typically standalone vessels or dedicated processing machines rather than compact closure assemblies. They are not configured as caps that can be mounted on standard storage containers, nor do they integrate passive moisture-control elements within the closure itself. As a result, such systems are unsuitable for long-term storage applications where modularity, portability, and compatibility with existing containers are required.

Certain references disclose container structures incorporating desiccant chambers within a body or housing, such as U.S. Pat. No. 7,427,314, which teaches methods for retaining desiccant material within a container structure to allow gas exchange while preventing contamination. While these teachings are relevant to desiccant containment techniques, they do not disclose or suggest a cap-based assembly that integrates a dedicated vacuum interface and a motor-driven mixing mechanism within a single closure.

More recently, European patent publication EP 4 534 436 A1 describes a sealing cap having a receptacle for atmosphere-regulating material positioned within the cap body. This reference demonstrates contemporary efforts to regulate container headspace conditions through cap-integrated materials. Nevertheless, it does not disclose a cap assembly that is configured to introduce vacuum via an external vacuum source, nor does it include any powered mixing mechanism extending into the container.

Commercial desiccant breather devices, such as tank breathers used in industrial equipment, are also known for conditioning incoming air through desiccant cartridges. These devices are designed primarily for pressure equalization and moisture filtration during air exchange events. They do not maintain an evacuated container headspace and are not intended to function as sealed storage closures, nor do they provide any internal mixing capability.

In contrast to the foregoing prior art, the present invention provides a single, integrated cap assembly that combines (i) a dedicated vacuum port configured for connection to an external vacuum source, (ii) a motor-driven mixing assembly extending into the container for maintaining homogeneity without opening the container, and (iii) a passive desiccant element positioned within the cap to remove residual moisture from the container headspace. Importantly, the vacuum path is structurally separate from the mixing shaft 208, and the shaft does not function as a conduit for vacuum or fluid flow.

Furthermore, the present invention employs a bottom-opening cap configuration, which represents a physical design choice that facilitates assembly, servicing, and replacement of internal components such as the desiccant element or mixing components. This structural configuration does not alter the functional operation of the vacuum, mixing, or moisture-control features, and such an arrangement is not disclosed or suggested in the cited prior art references.

Accordingly, while individual aspects of the present invention—such as desiccant-based moisture control, agitation through a container opening, or vacuum application—may be known independently, the prior art does not disclose or suggest their combined integration within a modular cap assembly that maintains a sealed container environment, applies vacuum through a dedicated port, mixes contents without container opening, and removes residual moisture through passive means. The present invention therefore addresses long-standing limitations of conventional container closures and represents a structurally and functionally distinct solution over the cited prior art.

### SUMMARY OF THE INVENTION

The present invention provides an improved container closure system in the form of a vacuum cap assembly configured to be mounted on an opening of a container or tank. The invention is directed to preserving stored materials by actively managing the internal environment of the container while maintaining a sealed condition. In particular, the invention integrates vacuum application, internal mixing, and passive moisture removal into a single cap assembly, thereby addressing degradation, settling, and contamination issues commonly associated with conventional storage containers.

In one aspect, the invention includes a cap housing configured to sealingly engage a container opening. The cap housing supports a dedicated vacuum port adapted for connection to an external vacuum source. When connected, the vacuum port enables evacuation of air from the container headspace, thereby reducing oxygen exposure and limiting interaction between the stored material and the ambient environment. The vacuum function operates independently of any moving components within the cap and does not rely on vacuum transmission through a rotating shaft or internal conduit.

In another aspect, the cap assembly incorporates a motor-driven mixing mechanism extending into the interior of the container. The mixing mechanism includes a motor 206 mounted within or above the cap housing and a solid shaft coupled to a mixing element positioned inside the container. Upon actuation, the motor rotates the shaft and mixing element to agitate the stored material, thereby maintaining homogeneity, preventing stratification, and ensuring even distribution of additives or components. This mixing operation may be performed while the container remains sealed, eliminating the need to open the container for manual agitation.

In a further aspect, the invention includes a passive moisture-control system integrated within the cap assembly. The moisture-control system comprises a desiccant element positioned within the cap housing and in fluid communication with the container headspace. The desiccant passively absorbs residual moisture present within the sealed container, thereby reducing humidity levels over time. The desiccant element may be configured as a cartridge or replaceable unit, allowing servicing or replacement without requiring modification of the container itself.

The vacuum, mixing, and moisture-control functions are designed to operate concurrently or independently, depending on application requirements. Vacuum may be applied continuously or intermittently through the dedicated vacuum port, while the mixing mechanism may be activated as needed to maintain material uniformity. The passive desiccant continuously removes moisture without requiring airflow, power, or mechanical actuation. Together, these functions create a controlled internal environment that enhances material stability and extends usable storage life.

In one embodiment, the cap assembly is configured as a bottom-opening structure, wherein internal components such as the mixing shaft 208, mixing element, or desiccant element are accessible from the lower portion of the cap housing. This bottom-opening configuration represents a physical design arrangement that facilitates assembly, inspection, cleaning, and replacement of internal components. The orientation of the opening does not alter the functional operation of the vacuum, mixing, or moisture-removal features and is provided as a structural design choice to improve serviceability and manufacturability.

The cap housing may further include sealing elements, such as gaskets or O-rings, configured to maintain an airtight seal between the cap assembly and the container opening. These sealing elements ensure retention of the vacuum environment and prevent ingress of ambient air or moisture during storage and operation. The housing may be adapted for threaded, clamped, or otherwise secured attachment to a wide range of container types and sizes.

The invention is modular in nature and may be scaled or adapted for use with containers ranging from small laboratory vessels to larger industrial tanks. The vacuum cap assembly may be manufactured from materials selected for chemical compatibility, durability, and ease of cleaning, and may be configured to accommodate different mixing geometries, motor types, or desiccant capacities without departing from the core inventive concept.

By integrating vacuum evacuation, internal mixing, and passive moisture control into a single closure assembly, the present invention eliminates the need for multiple separate devices or repeated container opening. The system reduces exposure to air and humidity, minimizes contamination risk, and maintains material consistency during storage. These advantages make the invention particularly well suited for applications where material stability, cleanliness, and long-term preservation are critical.

Accordingly, the invention provides a compact, serviceable, and functionally integrated vacuum cap system that overcomes the limitations of conventional container closures and prior art solutions. While various embodiments and configurations are described, it will be understood that the invention is not limited thereto, and that modifications and variations may be made without departing from the spirit and scope of the invention as defined by the appended claims.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE ACCOMPANYING DRAWINGS

The aforesaid as well as other objects and advantages of the invention will appear hereinafter from the following description taken in connection with the accompanying drawings in which:

FIG. 1 illustrates a perspective view of the assembled mixer cap system, showing the cap housing with upper surface ports and a mixing shaft 208 extending downward from the cap into the container, terminating in a mixing element configured to agitate material within the container.

FIG. 2 shows an exploded perspective view of the mixer cap assembly, illustrating the relative arrangement of the upper cap 202 portion, lower cap 204 portion, motor 206, shaft adapter, mixing shaft 208, and mixing element, thereby depicting the modular construction and assembly sequence of the cap.

### DETAILED DESCRIPTION OF THE INVENTION

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

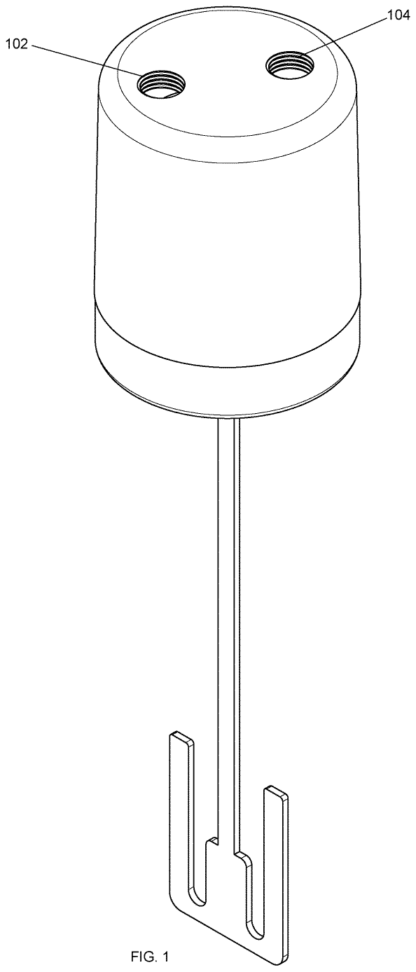

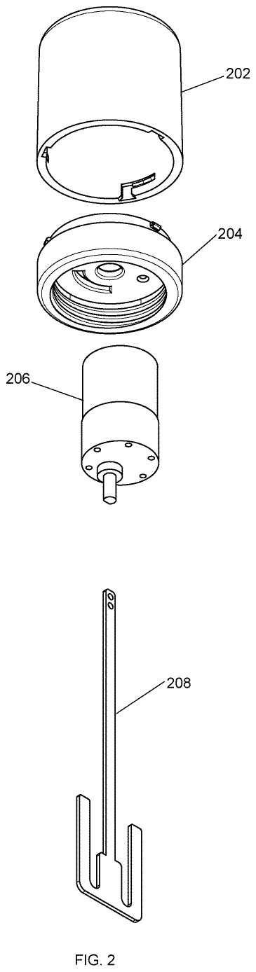

With reference now to the drawings, and in particular from FIG. 1 to FIG. 2 thereof, an advanced vacuum cap system embodying the principles and concepts of the present invention is described.

The present invention relates to an integrated container closure system configured as a vacuum cap assembly that actively manages the internal environment of a container while maintaining the container in a sealed condition. The cap assembly is structured to be mounted on a container opening and includes a cap housing having a dedicated vacuum port for connection to an external vacuum source, a motor-driven mixing mechanism extending into the container, and a passive moisture-control element positioned within the cap. In operation, air is evacuated from the container headspace exclusively through the dedicated vacuum port, thereby reducing oxygen exposure without routing vacuum through the mixing shaft 208 or other moving components. The mixing mechanism, comprising a motor 206, a solid mixing shaft 208, and a mixing element, operates to agitate and homogenize the contents of the container while the container remains sealed, preventing settling or stratification without requiring container opening. Simultaneously, the passive desiccant element absorbs residual moisture present within the container headspace, reducing humidity over time without the need for active airflow or power. The cap assembly is further configured as a bottom-opening structure, enabling internal components to be accessed, serviced, or replaced from the lower side without disturbing external vacuum or power connections, a design choice that enhances serviceability without altering functional operation. By integrating vacuum application, internal mixing, and moisture control within a single modular cap assembly, the invention provides a compact, efficient, and adaptable solution for preserving material stability, consistency, and freshness during storage while minimizing exposure to ambient conditions and reducing handling complexity.

Referring now to FIG. 1, a perspective view of an assembled mixer cap system is illustrated. The mixer cap system is configured to be mounted to an opening of a container for managing and preserving material stored within the container. The system is shown in its fully assembled state to illustrate the external configuration of the cap housing and the relative positioning of the mixing components extending into the container interior.

As shown in FIG. 1, the mixer cap system includes a cap housing that defines the primary structural body of the assembly. The cap housing is generally cylindrical in form and is configured to sealingly engage a container opening using an appropriate attachment interface, such as threads, clamps, or other securing mechanisms. The housing provides structural support for internal components while maintaining a sealed interface between the container interior and the external environment.

The upper surface of the cap housing includes one or more ports formed therein. These ports are positioned on the upper surface to provide external access points without interfering with the mixing components extending into the container. In one embodiment, the ports include a vacuum port 102 configured to be coupled to an external vacuum source and a separate port 104 configured to supply electrical power to an internal motor 206. The ports are arranged to remain accessible during operation while preserving the sealed condition of the container.

Extending downward from the cap housing is a mixing shaft 208 that passes through the interior of the cap housing and projects into the container when the cap is installed. The mixing shaft 208 is configured as a solid elongate member whose primary function is to transmit rotational motion from a motor 206 housed within the cap to a mixing element located inside the container. The mixing shaft 208 does not define a fluid passage and does not form part of any vacuum flow path.

A mixing element is mounted at a lower end of the mixing shaft 208. The mixing element is configured to engage and agitate material stored within the container when the mixing shaft 208 is rotated. In the illustrated embodiment, the mixing element includes laterally extending portions configured to generate fluid movement within the container, thereby promoting homogenization, preventing settling, and maintaining uniform distribution of components within the stored material.

The mixing element is positioned such that it extends sufficiently into the container to interact with the stored material while remaining spaced from container walls to avoid interference during rotation. The geometry of the mixing element may vary depending on application requirements, and FIG. 1 illustrates one non-limiting example of a mixing configuration suitable for generating effective internal agitation.

The cap housing encloses a motor assembly (not visible in FIG. 1) that is operatively coupled to the mixing shaft 208. When energized, the motor 206 rotates the mixing shaft 208 and mixing element to agitate the contents of the container. The motor 206 is housed within the cap housing and isolated from the container interior to protect the motor 206 from exposure to stored material or vapors.

FIG. 1 further illustrates the compact and integrated nature of the mixer cap system, in which the mixing mechanism is incorporated into the cap itself rather than requiring a separate mixing device or container opening. This configuration allows mixing to occur while the container remains sealed, thereby reducing exposure of the stored material to ambient air and moisture.

In operation, the mixer cap system shown in FIG. 1 may be mounted on a container and used to periodically or continuously mix the container contents as needed. The mixing function may be performed independently or in conjunction with other features of the cap system, such as vacuum application or moisture control, without requiring removal of the cap from the container.

Accordingly, FIG. 1 illustrates a mixer cap system that integrates container sealing and internal mixing into a single assembly, providing a practical and efficient solution for maintaining material uniformity and stability during storage.

Referring now to FIG. 2, an exploded perspective view of the mixer cap assembly is illustrated. This figure depicts the individual components of the mixer cap system in a separated, vertically aligned configuration to clearly show their relative positions, structural relationships, and assembly sequence. FIG. 2 is particularly useful for understanding the modular nature of the cap assembly and how the various components cooperate when assembled.

As shown in FIG. 2, the mixer cap assembly includes an upper cap 202 portion and a lower cap 204 portion that together define the cap housing when assembled. The upper cap 202 portion forms an exterior top section of the cap and provides a surface through which one or more ports may be formed. The lower cap 204 portion forms a lower section of the cap housing and is configured to interface with a container opening. When assembled, the upper and lower cap 204 portions cooperate to enclose internal components while maintaining a sealed interface with the container.

The exploded view of FIG. 2 illustrates that the upper cap 202 portion and lower cap 204 portion are separable components, allowing access to internal elements of the cap assembly from the lower side. This bottom-opening configuration facilitates assembly, inspection, servicing, and replacement of internal components without requiring disassembly from the top side of the cap or removal of external connections.

Positioned below the upper cap 202 portion in FIG. 2 is a motor. The motor 206 is configured to generate rotational motion for driving the mixing components of the system. The motor 206 is sized to fit within the interior volume defined by the assembled cap housing and is arranged to remain isolated from the container interior when the cap is installed.

The motor 206 includes an output interface configured to couple with a shaft adapter. The shaft adapter is shown as a separate component positioned between the motor 206 and a mixing shaft 208. The shaft adapter serves as a mechanical coupling that transmits rotational motion from the motor 206 to the mixing shaft 208 while allowing for ease of assembly and disassembly. The adapter may also accommodate alignment tolerances between the motor output and the mixing shaft 208.

The mixing shaft 208 extends downward from the shaft adapter and is configured as an elongate, solid member. As illustrated in FIG. 2, the mixing shaft 208 is sized to extend through the cap housing and into the container when the cap is assembled and mounted. The mixing shaft 208 functions solely to transmit rotational motion from the motor 206 to a mixing element and does not define any fluid passage or vacuum conduit.

Mounted at a lower end of the mixing shaft 208 is a mixing element. The mixing element is configured to engage material stored within the container and to generate internal movement of the material when rotated. FIG. 2 illustrates one example of a mixing element having laterally extending portions configured to produce agitation and circulation within the container. The specific geometry of the mixing element may vary depending on application requirements and is not limited to the illustrated configuration.

The exploded arrangement shown in FIG. 2 further illustrates how the mixing shaft 208 and mixing element are positioned relative to the lower cap 204 portion. When assembled, the mixing shaft 208 passes through an opening in the lower cap 204 portion, allowing the mixing element to extend into the container interior while the remaining components are retained within the cap housing.

FIG. 2 also illustrates the modular nature of the mixer cap assembly, wherein individual components such as the motor 206, shaft adapter, mixing shaft 208, and mixing element may be assembled or replaced independently. This modular construction enhances serviceability and allows the mixer cap system to be adapted for different container sizes, mixing requirements, or operating conditions.

When the components shown in FIG. 2 are assembled, the upper cap 202 portion and lower cap 204 portion cooperate to enclose the motor 206 and shaft adapter, while the mixing shaft 208 and mixing element extend downward from the cap housing into the container. In this assembled configuration, the mixer cap system enables internal mixing of container contents while maintaining a sealed container environment.

Accordingly, FIG. 2 illustrates the structural organization and assembly sequence of the mixer cap system, emphasizing the bottom-opening cap design, the modular arrangement of internal components, and the separation between the mixing mechanism and any external interfaces provided on the cap housing.

The invention operates as an integrated container closure system that manages the internal environment of a container while maintaining the container in a sealed condition. Once the cap assembly is mounted onto a container opening, the system enables controlled vacuum application, internal mixing of stored material, and passive moisture removal without requiring removal of the cap or exposure of the container contents to the external environment.

In use, the cap assembly is first secured to the opening of a container containing a material to be stored or preserved. The cap housing forms a sealed interface with the container opening through appropriate engagement features and sealing elements. Upon installation, internal components of the cap, including the mixing shaft 208 and mixing element, extend into the container interior while remaining supported by the cap housing.

To reduce the presence of air and oxygen within the container, an external vacuum source is connected to a dedicated vacuum port provided on the upper surface of the cap housing. When the external vacuum source is activated, air is evacuated from the container headspace through the vacuum port. The vacuum path is confined to the dedicated port and associated internal passages and does not involve the mixing shaft 208 or motor components. This evacuation step reduces oxygen concentration and limits exposure of the stored material to ambient air.

After evacuation, the container may be maintained under reduced pressure for storage or until further processing. The vacuum may be applied continuously or intermittently depending on application requirements. Because the vacuum port is separate from moving components, vacuum conditions can be maintained without interference from the mixing mechanism.

To maintain uniformity of the stored material, the internal mixing mechanism may be activated while the container remains sealed. Electrical power is supplied to the motor 206 housed within the cap through a power port or internal power connection. When energized, the motor rotates the mixing shaft 208, which in turn drives the mixing element positioned within the container.

As the mixing element rotates, it generates internal movement of the stored material, promoting circulation, preventing settling or stratification, and ensuring even distribution of any additives or components present within the material. This mixing operation may be performed periodically or continuously as needed, without opening the container or disrupting the vacuum condition established within the container.

Simultaneously with vacuum and mixing operations, the passive moisture-control function of the cap assembly operates continuously. A desiccant element positioned within the cap housing is in fluid communication with the container headspace. The desiccant passively absorbs residual moisture present in the sealed environment, thereby reducing humidity levels over time. This moisture removal occurs without requiring airflow, power, or mechanical actuation.

The combination of reduced oxygen content, controlled pressure, continuous moisture absorption, and internal mixing creates a stable internal environment that enhances preservation of the stored material. Degradation caused by air exposure, moisture, or uneven composition is thereby minimized during storage or handling.

When servicing or maintenance of the cap assembly is required, the bottom-opening configuration of the cap allows access to internal components from the lower side. The lower cap 204 portion may be separated from the upper cap 202 portion to permit removal, inspection, or replacement of components such as the mixing element, mixing shaft 208, or desiccant element. This servicing operation can be performed without disconnecting external vacuum or power connections provided on the upper surface of the cap.

After servicing, the lower cap 204 portion is reattached to the upper cap 202 portion, restoring the assembled configuration of the cap housing. The cap assembly can then be returned to normal operation, continuing vacuum maintenance, mixing, and moisture control without altering the working principles of the system.

Accordingly, the invention operates as a modular, serviceable, and integrated cap system that enables environmental control and material mixing within a sealed container. The working of the invention allows preservation and stabilization of stored materials while reducing handling steps, minimizing contamination risk, and improving operational efficiency.

The integrated vacuum cap system described herein is applicable across a wide range of storage, preservation, and processing environments where control of container headspace atmosphere and maintenance of material homogeneity are important. The following non-limiting use case scenarios illustrate representative applications of the invention.

In chemical manufacturing and formulation environments, many liquids and semi-liquids are sensitive to oxygen and moisture exposure. Examples include isocyanate-containing materials, moisture-curing polyurethane systems, epoxy resins, catalysts, and solvent-borne coatings. Such materials may react with atmospheric moisture or oxygen during storage, leading to degradation, viscosity change, or reduced reactivity.

The vacuum cap system may be mounted on storage containers holding such materials. Headspace air is evacuated through the dedicated vacuum port, reducing oxygen concentration, while the internal desiccant removes residual moisture. Periodic activation of the mixing assembly prevents settling of fillers or additives. This controlled environment extends shelf life and preserves formulation properties without requiring container opening.

Many adhesives and sealants cure upon exposure to humidity or oxygen. Containers storing partially used material often degrade rapidly once opened due to repeated air exposure. The invention allows the container to be resealed and evacuated after each use, restoring low-oxygen and low-humidity conditions. The passive desiccant further reduces moisture ingress. Internal mixing maintains uniformity of suspended components such as fillers or curing agents.

Certain pharmaceutical preparations, biological reagents, and laboratory chemicals are sensitive to oxidation, hydrolysis, or phase separation. Storage under controlled atmospheric conditions is often required to maintain potency and stability. The vacuum cap system enables evacuation of headspace gases and moisture control while maintaining sterile or closed-container conditions. Gentle internal mixing can be performed without opening the vessel, reducing contamination risk.

Oxygen exposure contributes to oxidation, flavor degradation, and spoilage in certain food and beverage products such as sauces, concentrates, syrups, emulsions, and liquid flavorings. Moisture migration and phase separation may also occur during storage. The invention enables evacuation of oxygen from headspace and maintenance of product uniformity through internal mixing. This may extend shelf life and preserve sensory characteristics in sealed storage containers.

Coatings, inks, pigment dispersions, slurries, and suspensions commonly experience settling or stratification during storage. Conventional remixing requires opening the container, exposing contents to air and moisture. With the present invention, the internal mixing assembly may be activated while the container remains sealed and under vacuum. This maintains dispersion uniformity and eliminates repeated opening cycles.

Process fluids such as lubricants, specialty oils, reactive intermediates, and treatment solutions may degrade when exposed to air or humidity during storage between process steps. The vacuum cap system enables controlled storage in drums or tanks with maintained vacuum and moisture reduction. Periodic mixing ensures consistent composition prior to reuse in downstream processes.

Agricultural chemicals, fertilizers, pesticides, and specialty liquid formulations may contain suspended solids or moisture-sensitive actives. Storage under uncontrolled atmospheric conditions can lead to settling or chemical degradation. The vacuum cap assembly maintains low-moisture headspace and allows agitation prior to dispensing without exposing contents to ambient conditions.

In many industries, containers are opened repeatedly to remove portions of stored material. Each opening introduces air and humidity, accelerating degradation. After each use, the vacuum cap system can be reattached and connected to a vacuum source to re-evacuate the headspace. The desiccant element absorbs residual moisture introduced during opening. This enables repeated access while preserving remaining contents.

Reactive materials stored for extended periods, such as two-part systems, catalysts, or oxygen-sensitive chemicals, require stable environmental conditions. The combined vacuum and desiccant functions of the invention maintain a controlled atmosphere over long durations, while occasional mixing prevents phase separation or sedimentation.

During transportation, vibration and temperature variation may cause separation or settling in stored fluids. The vacuum cap system can be used on transport containers to maintain sealed, low-oxygen conditions. Upon arrival, internal mixing can restore homogeneity before use without opening the container.

The invention may be applied to containers of various sizes including laboratory bottles, pails, drums, intermediate bulk containers (IBCs), and storage tanks. The modular cap assembly allows adaptation to different container geometries while maintaining the same functional principles of vacuum evacuation, moisture absorption, and internal mixing.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclosed herein suitably may be practiced in the absence of any element which is not specifically disclosed herein - and in particular embodiment specifically contemplated, is intended to be practiced in the absence of any element which is not specifically disclosed herein.

1. A container closure system, comprising:
a cap assembly configured for sealed attachment to an opening of a container, the cap assembly comprising a cap housing defining an internal volume;
a vacuum port disposed on the cap housing and configured to be coupled to an external vacuum source;
an internal vacuum passage formed within the cap housing and placing the vacuum port in fluid communication with a headspace of the container when the cap assembly is attached thereto;
a mixing assembly comprising:
a motor supported by the cap housing,
a non-hollow mixing shaft operatively coupled to the motor and extending through the cap housing, and
a mixing element mounted to a distal end of the mixing shaft and positioned to extend into the container; and
a moisture-control assembly comprising a desiccant-containing element disposed within the cap housing and in fluid communication with the headspace;
wherein:
the cap assembly includes at least one sealing element configured to form an airtight seal between the cap housing and the container opening,
the internal vacuum passage is structurally independent of and isolated from the mixing shaft, such that no vacuum or fluid flow is conducted through the mixing shaft, and
the cap assembly is configured to permit evacuation of the headspace, operation of the mixing assembly, and moisture absorption while the container remains sealed.

2. The system of claim 1, wherein the mixing shaft is a solid elongate member that does not define an internal channel.

3. The system of claim 1, wherein the internal vacuum passage comprises one or more channels formed within walls of the cap housing.

4. The system of claim 1, wherein the desiccant-containing element is disposed within a replaceable cartridge removably received in the cap housing.

5. The system of claim 1, wherein the cap housing comprises an upper portion and a separable lower portion.

6. The system of claim 5, wherein the lower portion is removable to provide access to internal components including the mixing assembly and the moisture-control assembly.

7. The system of claim 1, wherein the motor is disposed within the cap housing and isolated from the container interior by a sealed barrier.

8. The system of claim 1, wherein the mixing element comprises one or more laterally extending portions configured to generate agitation within the container.

9. The system of claim 1, wherein the vacuum port is positioned on an upper surface of the cap housing.

10. The system of claim 1, wherein the cap assembly is configured such that the mixing assembly is operable while the headspace is under reduced pressure.

11. The system of claim 1, wherein the moisture-control assembly is configured to passively absorb water vapor without active airflow.

12. The system of claim 1, wherein the cap assembly is configured as a modular unit removable from the container as a single piece.

13. The system of claim 1, wherein the cap housing is configured for attachment by threaded engagement or other securing mechanisms.

14. The system of claim 1, wherein the cap assembly is dimensioned for use with containers selected from bottles, pails, drums, tanks, and intermediate bulk containers.

15. A container closure system, comprising:
a cap assembly configured to be mounted on a container opening, the cap assembly comprising:
an upper housing portion and a lower housing portion that together define an internal cavity, the lower housing portion being removably coupled to the upper housing portion to provide bottom-side access to the internal cavity;
a vacuum port in fluid communication with a container headspace through a dedicated internal passage formed in the upper housing portion;
a motor mounted within the internal cavity;
a solid, non-hollow shaft driven by the motor and extending through the lower housing portion into the container;
a mixing element attached to the shaft; and
a desiccant element disposed within the internal cavity and exposed to the headspace;
wherein the dedicated internal passage is separate from and non-communicating with the shaft, and
wherein removal of the lower housing portion enables servicing or replacement of at least one of the shaft, mixing element, or desiccant element without disconnecting the vacuum port.

16. A method of preserving contents of a container, comprising:
sealingly attaching a cap assembly to an opening of the container to form an airtight enclosure;
connecting a vacuum port of the cap assembly to an external vacuum source;
evacuating air from a headspace of the container through a dedicated internal passage within the cap assembly, wherein the passage is independent of a mixing shaft extending into the container;
operating a motor within the cap assembly to rotate a non-hollow mixing shaft and thereby agitate contents of the container while the container remains sealed and under reduced pressure; and
passively absorbing moisture from the headspace using a desiccant-containing element disposed within the cap assembly.

17. The method of claim 16, further comprising maintaining the container under reduced oxygen concentration and reduced humidity during storage.

18. The method of claim 16, further comprising periodically activating the mixing shaft to prevent settling or stratification of container contents.

19. The method of claim 16, further comprising removing a lower portion of the cap assembly to access and replace the desiccant-containing element.

20. The method of claim 16, wherein the evacuation, mixing, and moisture absorption steps are performed without opening the container.
